(19) United States
(12) Patent Application Publication
(10) Pub. No.: US 2018/0210950 A1
(43) Pub. Date: Jul. 26, 2018

(54) DISTRIBUTED FILE SYSTEM WITH TENANT FILE SYSTEM ENTITY

(71) Applicant: HEWLETT PACKARD ENTERPRISE DEVELOPMENT LP, Houston, TX (US)

(72) Inventors: Boris Zuckerman, Marblehead, MA (US); Vitaly Oratovsky, Newton, MA (US)

(21) Appl. No.: 15/742,833

(22) PCT Filed: Jul. 16, 2015
(86) PCT No.: PCT/US2015/040722

§ 371 Date: Jan. 8, 2018

(51) Int. Cl. G06F 17/30

(52) U.S. Cl. CPC G06F 17/30604; G06F 17/30129; G06F 17/30194

(57) ABSTRACT

According to some examples, a tenant-aware distributed file system is provided that permits a tenant to be recorded and associate the tenant with a set of file system entities in a name space in the tenant-aware distributed file system. In particular, a tenant file system entity may be defined and recorded in a tenant-aware distributed file system, and the tenant file system entity may be associated with a set of file system entities in the name space of the tenant-aware distributed file system. The tenant file system entity may be associated with a set of attributes that are to be applied by tenant-aware distributed file system to the set of file system entities associated with the tenant file system entity. The set of attributes included by a tenant file system entity can include a statically inherited attribute, a dynamically inheritable attribute, or both.

### BACKGROUND

Data stored in a storage system can be organized into files and directories of a file system. A large storage system typically has a large number of computer nodes. As a result, information associated with the file system can be a distributed across the computer nodes. Performing certain operations in a distributed file system can be complex and can result in inefficiency if not performed properly.

### BRIEF DESCRIPTION OF THE DRAWINGS

Certain examples are described in the following detailed description in reference to the following drawings.

FIGS. 1 and 2 are flowcharts illustrate example methods for implementing tenant-aware file distribution file systems according to the present disclosure.

FIGS. 3 and 4 are diagrams illustrating example tenant-aware distributed file systems according to the present disclosure.

FIG. 5 is a block diagram illustrating an example entry point server of an example tenant-aware distributed file system according to the present disclosure.

FIG. 6 is an example computer system for implementing a tenant-aware file distribution file system according to the present disclosure.

### DETAILED DESCRIPTION

A challenge posed by a large or complex distributed file system is that management tasks can be relatively complex, and can lead to inefficiency if appropriate measures are not taken. For example, traditional distributed file systems provide often provide tenant-level file system services by creating a separate file system for each tenant, or using a single file system and separating tenants by sub-directories. Generally such implementations result in inefficient and complex management of the distributed data associated with individual tenants, particularly when performing snapshots of data or applying various policies to data at the tenant-level.

Various examples describe systems and methods relating to a tenant-aware distributed file system. According to some examples, a tenant-aware distributed file system is provided that permits a plurality of tenants to be recorded on the tenant-aware distributed file system as individual tenant file system entities, and that further permits different sets of file system entities (e.g., file system roots and sub-directories) on the tenant-aware distributed file system to be associated with different tenants regardless of their location in the hierarchical name space of the tenant-aware distributed file system.

In particular, a tenant object or entity (hereafter, “tenant file system entity”) may be defined and recorded in a tenant-aware distributed file system, and the tenant file system entity may be associated with a set of file system entities in the name space of the tenant-aware distributed file system. The tenant file system entity may be associated with a set of attributes that are to be applied by tenant-aware distributed file system to the set of file system entities associated with the tenant file system entity. The set of attributes included by a tenant file system entity can include a statically inherited attribute, a dynamically inheritable attribute, or both.

For various examples, hierarchical organization of a tenant-aware distributed file system permits a set of attributes (e.g., properties) to be passed (e.g., inherited) from a parent node of the hierarchy (e.g., parent file system entity, such as a root directory) to a child node of the hierarchy (e.g., child file system entity, such a file or sub-directory of the root directory). Additionally, for various examples, such inheritance is accomplished statically or dynamically. As used herein, a statically inherited attribute refers to an attribute of a file system entity that is determined (e.g., calculated) at the creation of the file system entity, and which may be recorded as part of the metadata of the file system entity. In comparison, a dynamically inheritable attribute refers to an attribute of a file system entity that is determined (e.g., calculated or revalidated) by the tenant-aware distributed file system, at run-time, when a certain set of conditions are satisfied (e.g., when the dynamically inheritable attribute is needed or when it is checked for consistency during a validation process). Accordingly, the dynamically inheritable attribute is considered to be “inheritable” in the sense that the value of the attribute is propagated among two or more hierarchical file system entities (e.g., with respect to a dynamically inheritable attribute, child file system entity inherits value of the attribute from its parent file system entity). In the context of file system snapshots, the dynamically inheritable attribute can include a time property of the snapshot. For some examples, changes to a dynamically inheritable attribute of a parent node (e.g., root directory) immediately affects the dynamically inheritable attribute of a child node (e.g., a file or a sub-directory of a root), while changes to a statically inherited attribute of a parent node (e.g., root directory) affects only newly-created child nodes (e.g., newly-created file or sub-directory).

Tenant-aware distribute file systems described herein may be implemented using data storage segments, destination servers (DS) (also referred to herein as a “segment server”), and entry points servers (ES). As used herein, a data storage segment (hereinafter, “segment”) can include data stored on a contiguous range of a data storage medium (e.g., computer readable medium), and may include up to some predefined maximum size of data. The data storage medium may include a single data storage device (e.g., hard disk drive, solid state drive [SSD], persistent memory, etc.) or an array of such data storage devices. A segment may be used to maintain a collection of file system entities, including inodes that represent such file system entities as files, parts of files, root directories, or sub-directories. Additionally, file system entities (e.g., files or directories) in a particular segment can refer to file system entities in another segment. Individual segments may be exclusively managed by corresponding servers, referred to herein interchangeably as destination servers (DS) or segment servers. Destination servers may be coupled to their respective segments (e.g., to the data storage media storing the segments) directly or indirectly by way of a communications network, which may be implemented using Fibre Channel (FC), Internet Small Computer System Interface (iSCSI), serial attached SCSI (SAS), or other types of interconnects. For tenant-aware distributed file systems described herein, a destination server can serve as a final destination for management and storage of files, directories, tenant file system entities, or other file system entities.

For client computer systems wanting to access the tenant-aware distributed file system, an entry point server (ES) can serve as an entry point to the tenant-aware distributed file system and the data managed by the segment servers. An entry point server (ES) can run applications or provide access to the distributed file system through commonly used protocols such as the Network File System (NFS) protocol, Server Message Block (SMB) protocol, Hypertext Transfer Protocol (HTTP), File Transfer Protocol (FTP), and the like. A client computer system can request an entry point server (ES) to perform various file system operations on the tenant-aware distributed file system and, in response, the entry point server (ES) can send requests to relevant destination servers (DS) to perform corresponding data operations on a set of segments they manage. As a result, file system services provided by a tenant-aware distributed file system may involve destination servers (DS) and entry point servers (ES) exchanging messages over a communications network (e.g., Ethernet network). For some examples, the association between segments and destination servers is known to entry point servers (ES), thereby permitting the entry points servers (ES) to determine which destination servers are to receive data operations requests when a file operation is requested with respect to particular data on the tenant-aware distributed file system.

Various file system entities described herein may be represented by an in-core (also referred to as in-memory) inode (e.g., when being operated on by the entry point server), and an attribute (e.g., dynamically inheritable attribute) of a file system entity may be represented by a field in the inode (e.g., a dynamically inherited generation [dm_gen] field). As discussed herein, a dynamically inheritable attribute may be an attribute that is calculated (e.g., set) at run-time of the tenant-aware distributed file system, rather than being statically set (e.g., at creation of the file system entity. When stored, the dynamically inheritable attribute may be are recorded as a part of the meta-data of that file system entity.

In various examples, an attribute of a file system entity, such as a statically inherited attribute or a dynamically inheritable attribute, can be utilized to associate the file system entity with other types of file system entities. For example, by setting a value of a dynamically inheritable attribute of a file system entity (e.g., a root directory or sub-directory) with a tenant identifier (ID), the file system entity can be associated with a tenant file system entity sharing the same tenant ID. For some examples, a value set for an attribute of a tenant file system entity is propagated to other file system entities associated with the tenant file system entity. As discussed herein, the tenant file system entity may have a set of attributes including statically inherited attributes, dynamically inheritable attributes, or both.

An attribute of a file system entity (e.g., a statically inherited attribute or a dynamically inheritable attribute) can also be utilized with other file system entities. For instance, dynamically inheritable attributes can be used to implement snapshots in a tenant-aware distributed file system, whereby dynamically inheritable attributes of file system entities can contain values relating to snapshot relevant properties. As used herein, a “snapshot” can include a representation of data stored in a tenant-aware distributed system at a particular point in time. Accordingly, multiple snapshots of data may be taken at different points in time. Depending on the example, a snapshot can be taken of an entire file system, or some portion less than the entirety of the file system based on the based on the portions association to a set of tenants (e.g., snapshot of all file system entities associated with a tenant file system entity representing a particular tenant). If a user or an application needs access the file system in the state as it was in the past, then the tenant-aware distributed storage system can use a set of selected snapshot to recover data, depending on how far back in time a user or application wishes to recover data. A snapshot is just one example of a file system service, rule, policy, or object that may be applied to, or associated with, various file system entities stored on the tenant-aware distributed file system based on tenant association.

For some examples, a snapshot of a file system entity in the name space (e.g., file or directory) is facilitated by a Snapshot Time Mark (STM), which is a dynamically inheritable attribute that can be recorded with the file system entity. As a dynamically inheritable attribute, the STM for a given file system entity can be propagated to descendants of the given file system entity. The rule of propagation for STM may be such that the STM moves in one direction and STMs for snapshots grow monotonically. In view of this, an effective STM for a given file system entity is the largest value inherited from its parent or its own value. Accordingly, for some examples, when several snapshot requests are issued on different levels of the name tree the latest requests with the largest STM is inherited by descendants.

Use of dynamically inheritable attributes can permit snapshot relevant information relating to a particular snapshot to efficiently be propagated to all descendants of the file system entity after the particular snapshot has been created. For some examples, an inherited Snapshot Time Mark (STM) is used when the distributed file system needs to make a decision of whether a file system entity that is being deleted or modified has to be preserved as a part of the snapshot or can be erased because it is not a part of the snapshot. For instance, each file system entity in the name space (e.g., file or directory) includes a Birth Time Mark (BTM), which may be assigned to such file system entities when they are created and which may be set to the current applicable STM (e.g., based on inheritance and hierarchy). Depending on the example, the BTM may be calculated by an entry point server (ES) and passed to a destination server (DS) to be recorded to a data storage segment managed by the DS. When a given file system entity is to be removed, a current applicable STM is compared with the BTM of the given file system entity. If no new snapshots were requested on the affected part of the name space since creation of the given file system entity, the BTM would be identical to the current applicable STM and, as such, the given file system entity does not have to be preserved and can be safely erased. If newer snapshots were requested after the given file system was created, the current applicable STM would not match the BTM. The current applicable STM may be larger and, as such, the given file system is to be preserved. In this situation, the given file system may be marked by setting a Death Time Mark (DTM), which may be a dynamically inheritable attribute.

Subsequently, appending a desired Query Time Mark (QTM) to any element of the path in query requests permits examination of content of file entities (e.g., files and directories) as they were preserved at or before specified QTM (e.g., preserved by a snapshot). Any access at “current time” (now time) filters out all objects with an established Death Time Mark (DTM). However, when a tenant-aware distributed file system is to show a name space as it appeared at any point in the past, the system may filter out all the objects that either were not yet born at that time (Birth Time Mark that is larger than QTM) or if they were removed by that time (DTM is less or equal than QTM).

For various tenant-aware distributed file systems described herein, tenant-level snapshots is implemented by including a set of dynamically inheritable attributes in a tenant file system entity. In particular, a snapshot of file system entities associated with a tenant file system entity can be facilitated by populating a set of dynamically inheritable attributes of the tenant file system entity (associated with the tenant) with snapshot information. According to some examples, populating the set of dynamically inheritable attributes in this manner results in the snapshot information being propagated to each file system entity associated with the tenant file system entity, possibly during an attribute validation process discussed herein. When a user (e.g., file system administrator) can request a snapshot for all the data associated with a tenant, a new Snapshot Time Mark (STM) may be set on a tenant file system entity corresponding to the tenant.

Examples of other file system entities with which a given file system entity can be used include, without limitation, data replication policies, data placement rules, information that tracks data changes, security rules, audit policies, and the like. For instance, by setting values of various dynamically inheritable attributes of the given file system entity, the given file system entity can be associated with any of the foregoing entities at run-time of the tenant-aware distribute file system. Additionally, the set values of the given file system entity can be appropriately propagated among a set of file system entities (e.g., files, root directories, or sub-directories) related to (e.g., descending from) the given file system entity. A data replication policy can specify the number of replicas to make of file system entities (or groups of file system entities). A data placement rule can specify where a new file system entity is to be placed in the storage system. Information that tracks data changes can include information that tracks data changes made to selected file system entities. A security rule can specify security to be applied to selected file system entities. An audit policy can specify information to be associated with file system entities to allow for later audit.

Depending on the example, the value of a dynamically inheritable attribute associated with a file entity may be validated (e.g., calculated or refreshed) when they are to be used. In accordance with some examples, an entry point server is responsible for propagating a value of a dynamically inheritable attribute down a hierarchy of a distributed file system at run-time, and responsible for validating (e.g., calculating or refreshing) the dynamically inheritable attribute when appropriate. In instances when a destination server actions depend on values of a dynamically inheritable attribute, an entry point server may pass the value of the dynamically inheritable attribute to destination server(s) as parameters in messages, such as in RPC (remote procedure call) messages.

For various examples, the tenant-aware distributed file system can validate dynamic inheritable attributes of a given file system entity. During a validation process, a determination can be made whether the value of a given dynamically inheritable attribute of the given file system entity is to be refreshed. Additionally, during the validation process, the given dynamically inheritable attribute of a set of file system entities (e.g., all file system entities) along a hierarchical path from a particular file system entity (e.g., root node in the hierarchy) to the given file system entity (e.g., descendent node in the hierarchy) may be revalidated based on the value of the dynamically inheritable attribute of the particular file system entity. According to some examples, where the presence of a tenant file system entity related to the file system entity is detected, the hierarchical path begins with the tenant file system entity (e.g., tenant file system entity is injected into the beginning of the path), thereby permitting the value of the dynamically inheritable attribute of the tenant file system entity (if set) to propagate along the particular hierarchical path. Various examples may improve validation performance by intelligently determining that certain file system entities along the hierarchical path do not have to be re-validated when certain conditions are satisfied, as discussed further below. In this way, such examples can avoid traversing the entire chain of nodes (e.g., a sub-tree of file system entities) during a validation procedure.

In particular examples, a dynamically inherited generation (hereafter, “dm_gen”) field in an in-core inode representing a file system entity, such as a file, a directory, or a tenant file system entity, is utilized to propagate values of dynamically inheritable attributes from a root node (e.g., root file system entity) to descendant nodes (e.g., descendant file system entities) in the hierarchy of the tenant-aware distributed file system. The dm_gen field may be a vector comprising a set of various dynamically inheritable attributes (e.g., distinct inheritable properties, such as snapshot identifiers, data placement rules, security rules, etc.) to be propagated from a root nodes to descendant nodes. Additionally, the dm_gen field may be maintained by entry point servers (ES) in in-core inodes and may be copied from the parent of the inode (e.g., inode representing a root file system entity) to descendant inodes (e.g., inodes representing descendant file system entities) during the process of propagation of a dynamically inheritable attribute (e.g. a time property of a snapshot, such as Snapshot Time Mark).

The dm_gen field may be updated at the root inode (e.g., root directory) of the file system based on a dm_gen field of a descendant inode (e.g., sub-directory) being set or updated. For example where a snapshot is taken of the descendant inode and dm_gen field is updated to reflect that snapshot (e.g., its dynamically inheritable attribute representing Snapshot Time Mark [STM] is monotonically incremented), a similar change is made at the root inode. The modification of the dm_gen field at the root inode may be propagated from the root inode to other inodes during lookups or during a validation procedure to validate the dynamically inheritable attribute (e.g. STM).

As used herein, validation of a particular file system entity can include checking consistency of the particular file system entity's dynamically inheritable attributes based on association with a tenant, and propagating values of dynamically inheritable attributes when inconsistencies are detected. According to various examples, validation of the particular file system entity involves validating a particular inode representing the particular file system entity, and further involves traversing and validating a chain of inodes between the particular inode and the root inode serving as its root of inheritance (e.g., root based on a hierarchical name space path). During this validation, the dm_gen field can be confirmed to be the same for inodes (e.g., representing file system entities in the sub-tree) between the particular inode and its root inode. For purposes of efficiency, the dm_gen field of inodes can be used to determine when traversal and validation of a chain of inodes from the particular inode to the root inode can be stopped, thereby avoiding the need to validate all inodes in the chain.

For example, if during validation it is determined that the dm_gen field of the particular inode is different from the dm_gen field of the root inode, inodes starting from the particular inode to the root inode are iteratively added to a list so long as the dm_gen field of the inode to be added does not match the dm_gen field of the root inode. The adding of inodes to the list may stop when the dm_gen field of the next inode last added matches the dm_gen field of the root inode. In accordance with various examples, the resulting list is considered an ordered list, and the list may be ordered such that the last added inode is the first inode in the list.

After the list has been generated, if it is determined that the particular inode is associated with a tenant (e.g., extended field of the particular inode contains a tenant identifier associated with the tenant), a tenant inode representing a tenant file system entity associated with the tenant may be added to the beginning of the list generated. Accordingly, for some examples, if the particular inode is associated with a tenant, a corresponding tenant inode is disposed at the beginning of the list, and if otherwise, the last inode added to the list (having dm_gen field matching that of the root inode) is disposed at the beginning of the list. By disposing a tenant inode at the beginning of the list, various examples can designate the tenant inode (and the tenant file system entity it represents) as the root of inheritance for the other inodes on the list.

Eventually, validation process continues by propagating the dm_gen field of the first inode on the list (e.g., tenant inode, root inode, or last inode added) to all inodes in the list. In doing so, values of the set of dynamically inheritable attributes included by the dm_gen field can be propagated to all inodes in the list.

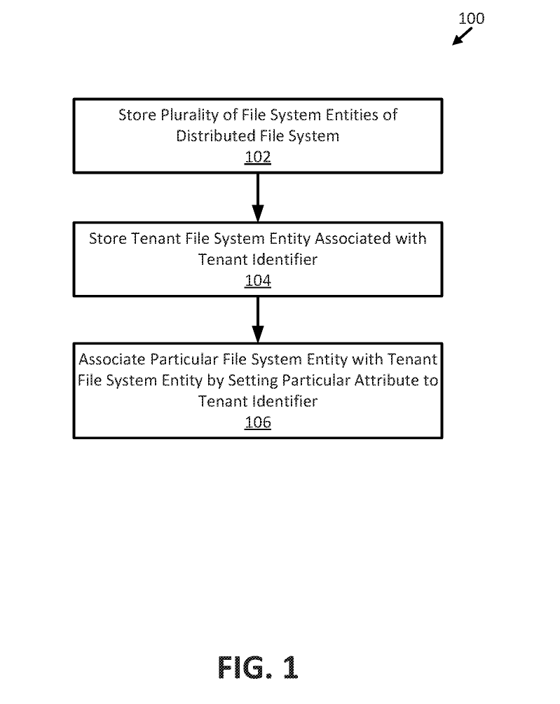

FIG. 1 is a flowchart illustrate an example method 100 for implementing tenant-aware file distribution file systems according to the present disclosure. For some examples, the method 100 may be one performed by an entry point server (ES) of a tenant-aware distributed file system described herein. The method 100 may be implemented in the form of executable instructions stored on a machine-readable medium or in the form of electronic circuitry.

As shown, the method 100 may begin at block 102 by a computer system storing, in a data storage system, a plurality of file system entities of a distributed file system that is hierarchically arranged. For some examples, the computer system may be an entry point server (ES) of the distributed file system that requests a destination server (DS) of the distributed file system, which is managing a set of segments on the data storage system, to store the plurality of file system entities in the segment. In some examples, the computer system may be the destination server itself, which facilitates the storage of the plurality of file system entities on the storage system (e.g., in a segment stored on the storage system). In further examples, performance of operations of the method 100 may be performed by the combination of an entry point server (ES) and destination server (DS). The data storage system may comprise a data storage medium (e.g., hard disk drive or an array of data storage devices) capable of storing a segment described herein.

The method 100 may continue to block 104 by the computer system storing, in the data storage system, a tenant file system entity associated with a tenant identifier. The tenant file system entity may include a dynamically inheritable attribute to be applied to a set of file system entities, in the distributed file system, associated with the tenant file system entity. As noted herein, the dynamically inheritable attribute of the tenant file system entity may include, without limitation, one that relates to a snapshot (e.g., Snapshot Time Mark, Restore Time Mark, etc.), a data placement policy, track-changes information, a security policy, an audit policy, or a data replication policy. In relation to a snapshot, a data placement policy, track-changes information, a security policy, an audit policy, or a data replication policy, setting a dynamically inheritable attribute of a tenant file system entity can facilitate the corresponding file system service at the tenant level.

The method 100 may continue to block 106 by the computer system associating a particular file system entity (e.g., sub-directory) in the plurality with the tenant file system entity by setting a particular attribute of the particular file system entity to the tenant identifier. According to some examples, the particular attribute being set to the tenant identifier is one dynamically inheritable attribute of the particular file system entity. Additionally, for some examples, the particular attribute being set to the tenant identifier is implemented as an extended attribute of an inode that represents the particular file system entity. By setting the particular attribute to the tenant identifier, the particular file system entity may effectively to point to the tenant file system entity. As discussed herein, this may facilitate consideration of a set of dynamically inheritable attributes of the tenant file system entity when validating attributes of the particular file system entity as described herein. For various examples, the association of the particular file system entity with the tenant file system entity is performed at run-time of the tenant-aware distributed file system. Additionally, for some examples, the validation of the particular file system entity may upon the particular file system entity being associated with the tenant file system entity.

As described herein, a dynamically inheritable attribute of a given file system entity (e.g., root directory, sub-directory, or tenant file system entity) may be implemented by a field (e.g., dm_gen field) of an inode representing the given file system entity. Additionally, the field of the inode may contained a vector representing a set of dynamically inheritable attributes that describe various distinct inheritable properties, such as snapshot identifiers, data placement rules, data security rules, and the like.

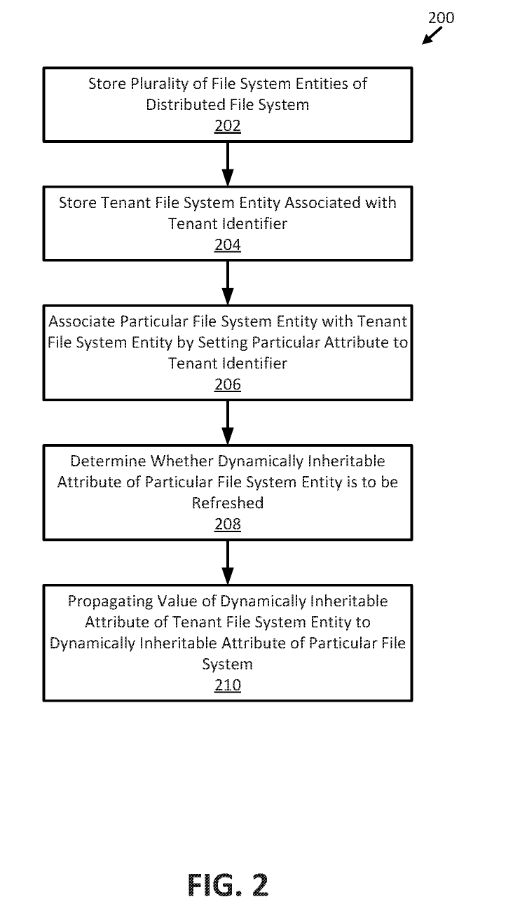

FIG. 2 is a flowchart illustrate an example method 200 for implementing tenant-aware file distribution file systems according to the present disclosure. For some examples, the method 200 may be one performed by an entry point server (ES) of a tenant-aware distributed file system described herein. The method 200 may be implemented in the form of executable instructions stored on a machine-readable medium or in the form of electronic circuitry.

As shown, the method 200 may begin at block 202 and continue to blocks 204 and 206, which may be respectively similar to blocks 102, 104, and 106 of the method 100 as described above with respect to FIG. 1.

The method 200 may continue to block 208 by a computer system (e.g., entry point server, destination server, or both) determining whether the dynamically inheritable attribute of the particular file system entity is to be refreshed (e.g., validated as described herein). Depending on the example, conditions that determine whether the dynamically inheritable attribute will be refreshed can include, without limitation, refreshing the dynamically inheritable attribute when the dynamically inheritable attribute is about to be used. For instance, where a dynamically inheritable attribute of the particular file system entity contains a Snapshot Time Mark, this dynamically inheritable attribute may be refreshed before it is used to determine whether the particular file system entity should be removed during a during a deletion process. Another condition may include, without limitation, refreshing the dynamically inheritable attribute when the particular file system entity has been modified, or when another attribute of the particular file system entity has been set or modified. Yet another condition may include refreshing the dynamically inheritable attribute when a tenant identifier is added, removed or modified with respect to the particular file system entity.

The method 200 may continue to block 210 by the computer system comprises propagating a value of the dynamical inheritable attribute of the tenant file system entity to at least the particular file system entity. The value of the dynamical inheritable attribute of the tenant file system entity may be propagated in response to the computer system determining (at block 208) that the dynamical inheritable attribute of the particular file system needs to be refreshed.

During the refresh, the computer system may evaluate whether the value of the dynamically inheritable attribute of the particular file system entity matches the value of the dynamically inheritable attribute of the root of inheritance (RI) of the particular file system entity. The root of inheritance of the particular file system entity may be the root file system entity (e.g., root directory) of the particular file system entity (e.g., sub-directory) based on the hierarchical name space path of the particular file system entity.

Where it is determined that the value of the dynamically inheritable attribute of the particular file system entity does not match the value of the dynamically inheritable attribute of the root of inheritance, propagation of the value at block 210 may be performed as follows. Initially the computer system may identify, in the plurality of file system entities, a set of file system entities from the particular file system entity to the root of inheritance, where the dynamically inheritable attribute of each file system entity in the set (of file system entities) has a specific value that is different from the value of the dynamic inheritable attribute of the particular file system entity. Identifying this set of file system entities can avoid having to propagation the value of the dynamically inheritable attribute to each file system entity between the particular file system entity and its root of inheritance, and can further limits propagation of the value to only those file system entities having an inconsistent value.

Subsequently, in response to the particular file system entity being associated with the tenant file system entity, the value of the dynamically inheritable attribute of the tenant file system entity may be propagated to the particular file system entity and to the identified set of file system entities. Alternatively, in response to the particular file system entity not being associated with the tenant file system entity, the value of the dynamically inheritable attribute of the root of inheritance (of the particular file system entity) to the particular file system entity and to the identified set of file system entities.

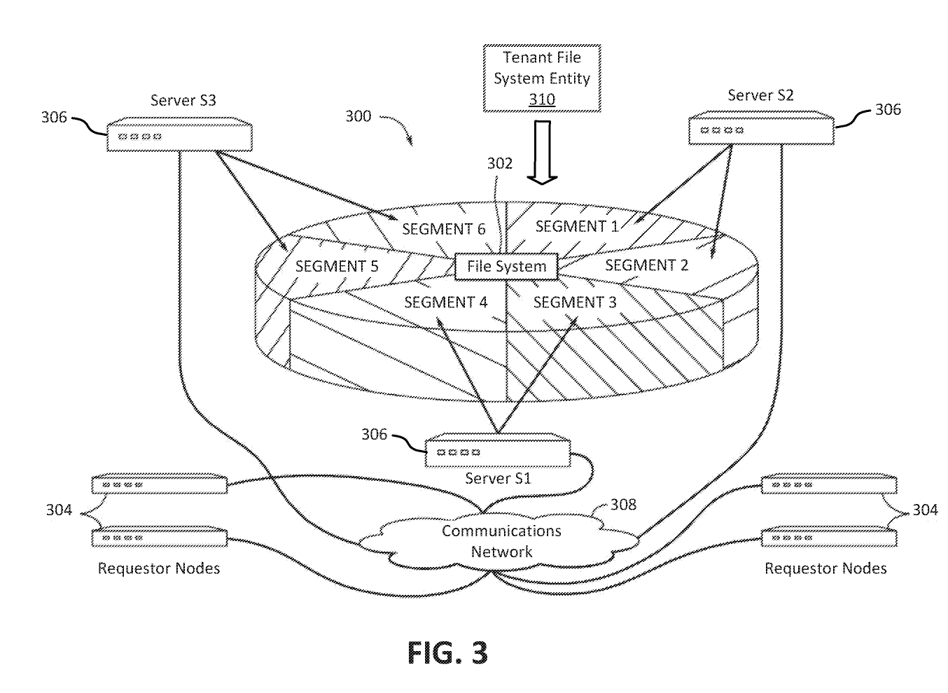

FIG. 3 is a diagram illustrating an example tenant-aware distributed file system 300 according to the present disclosure. As shown, the tenant-aware distributed file system 300 includes data storage segments 1-6 (collectively referred to herein as segments 302), computer systems functioning as requestor nodes 304, computer systems function as servers S1, S2, and S3 (collectively, referred to herein as segment servers 306), and a communications network 308 that facilitates communication between the requestor nodes 304 and the segment servers 306. As also shown, the tenant-aware distributed file system 300 is divided into the segments 302. For some examples, the servers 306 function as segment servers and, as such, may manage respective groups of the segments. For example, in FIG. 1 the server S1 is shown to manage segments 3 and 4, the server S2 is shown to manage segments 1 and 2, and the server S3 is shown to manage segments 5 and 6. The number of segments managed by each respective server can vary and can change over time. As described herein, a computing entity that manages that manages one or multiple segments is referred to herein as a destination server (DS) or a segment server.

As segment servers, each of the servers S1, S2, and S3 may be responsible for allocation of blocks and inodes within the boundaries of the respective individual segments they manage. As used herein, a file system entity can include one or multiple blocks of data, where each block is a predefined region of storage. An inode can be a data structure that stores information about a file system entity, such as a file or directory. Examples of information contained in an inode can include the following regarding its corresponding file system entity: type, length, access and modification times, location on a storage medium, owner, permissions, etc. An inode may not contain the actual data of the corresponding file system entity (e.g. the inode for a file does not contain the data for the file). For some examples, a tenant file system entity described herein may be stored on the tenant-aware distributed file system 300 as an inode, and the inode may be stored in a segment managed by one of the servers S1, S2, or S3.

The amount of storage that is associated with a segment server can be controlled. By allocating specific sets of segments to a segment server, an amount of storage managed by the segment server can correspond to a number of file system entities that the segments server controls. The division of the tenant-aware distributed file system 300 into served segments that are associated with respective segment servers can permit the tenant-aware distributed file system 300 to scale linearly. As more segments added to the tenant-aware distributed file system 300, correspondingly more segment servers can also be added. Additionally, computing entities function as entry points to the tenant-aware distributed file system 300 and to the segment servers can also be increased correspondingly.

Although just three servers 306 and six segments 302 are shown in FIG. 3, an actual distributed storage system can include a much larger number of servers and respective segments (e.g., the tenant-aware distributed file system 300 can include thousands of segments). In some examples, at any given time, each individual segment is exclusively controlled by a single corresponding segment server. For load balancing or fault tolerance purposes, the control of any given segment can be migrated from one segment server to another segment server.

FIG. 3 depicts various requestor nodes 304 that are communicatively coupled over the communications network 308 (e.g., local area network [LAN], storage area network [SAN], wide area network [WAN], Internet, etc.) to the servers S1, S2, and S3. Examples of the requestor nodes 304 include client computers (e.g., desktop computers, notebook computers, etc.) associated with users. Alternatively, the requestor nodes 304 can include segment servers that have to retrieve data served by other segment servers in the tenant-aware distributed file system 300.

In accordance with various examples, the tenant-aware distributed file system 300 implements tenant-level file system services, such as snapshots, data replication policies, data placement rules, information that tracks data changes, security rules, audit policies, and the like, through use of a tenant file system entity. In particular, a tenant is recorded on the tenant-aware distributed file system 300 as a tenant file system entity 310, which is stored on one of the segments 302 managed by one of the segment servers 306. Subsequently, to associate a given file system entity on the tenant-aware distributed file system 300 with the tenant, the given file system entity can be made to point to the tenant file system entity. Thereafter, to facilitate a specific tenant-level file system services on the file system entities associated with the tenant, including the given file system entity, a dynamically inheritable attribute relating to the specific file system service may be set or modified on the tenant file system entity. The resulting new value of the dynamically inheritable attribute may then be propagated to each file system entity that points to tenant file system entity. For some examples, the propagation of the new value may not occur with respect to the given file system entity until such time as the dynamically inheritable attribute of the given file system entity is refreshed, and the refresh process may not occur until a certain condition is met. For instance, the dynamically inheritable attribute of the given file system entity may not be refreshed until such time as the dynamically inheritable attribute of the given file system entity needs to be used to perform the specific tenant-level file system service on the given file system entity. Additionally, for some examples, propagation of a value of a dynamically inheritable attribute of a tenant file system entity may be performed efficiently using validation procedures described herein.

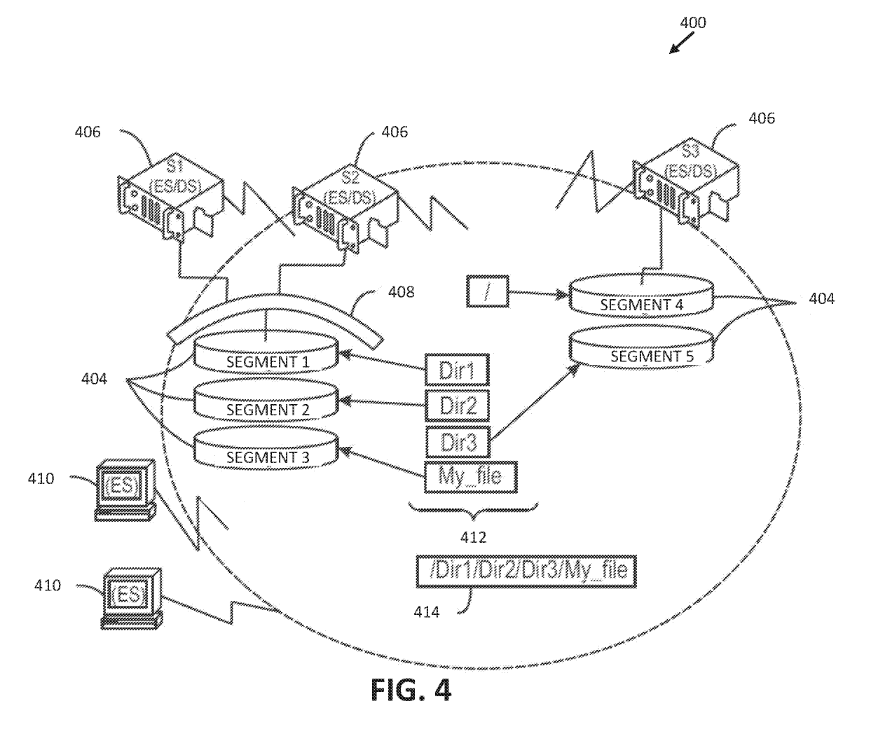

FIG. 4 is a diagram illustrating an example tenant-aware distributed file system 400 according to the present disclosure. As shown, the tenant-aware distributed file system 400 includes segments 1-5 (collectively referred to herein as segments 404), computer systems function as servers S1, S2, and S3 (collectively, referred to herein as servers 406), a communications network 408, and computer systems 410. For some examples, the computer systems S1, S2, and S3 correspond to servers S1, S2, and S3 of FIG. 1, and the computer systems 410 correspond to requestor nodes 304 of FIG. 1.

Each of computer systems 410 can correspond to one of the requestor nodes 304 of FIG. 1, and may function as an entry point server (ES). Depending on the example, each of the servers S1, S2, and S3 can function as a destination server (DS), an entry point server (ES), or both. As a destination server (DS), any of servers 406 can serve as a final destination for management of files, directories, tenant file system entities, or other file system entities. Additionally, as a destination server (DS), any of servers 406 can manage one or more of the segments 404. As an entry point server (ES), any of the computer systems 410 can facilitate a tenant-level file system operation (e.g., taking a snapshot) by sending a request to one or more of the servers 406 that are functioning as destination servers (DS). Additionally, as an entry point server (ES), any of the computer systems 410 may be aware of associations between the segments 404 and the one or more of the servers 406 that are functioning as destination servers (DS). This awareness permits those computer systems 410 (functioning as entry point servers) to send requests to the appropriate servers 406 when performing a tenant-level file system operation.

As shown, through the communications network 408, server S1, S2, or both may indirectly access any of segments 1-3. As described herein, the communications network 408 can be implemented using Fibre Channel (FC) interconnects, Internet Small Computer System Interface (iSCSI) interconnects, serial attached SCSI (SAS) interconnects, or other types of interconnects.

The tenant-aware distributed file system 400 implemented as shown in FIG. 4 is a hierarchically-arranged. Based on the hierarchical arrangement, the tenant-aware distributed file system 400 can includes file system entities at different levels in a hierarchy. The hierarchy can include a file at the lowest level, and directories at various intermediate levels and the root level. To achieve a high degree of parallelism, individual file system entities of the hierarchical arrangement can be widely distributed across many segments that are correspondingly controlled and served by different servers 406.

For example, as shown in FIG. 4, a file path /Dir1/Dir2/Dir3/My_file (414) indicates that the file My_file is located in a directory Dir3, which in turn is located in directory Dir2, which in turn is located in directory Dir1, which in turn is located under the root directory /. This example path name represents example file system entities (412) at five different hierarchal levels, where My_file is at the lowest hierarchal level, while the root directory / is at the highest hierarchal level and serves as the root of inheritance for each of My_file, Dir3, Dir2, and Dir1. According to some examples, the tenant-aware distributed file system 400 can associate one or more of the example file system entities 412 (My_file, Dir3, Dir2, Dir1, and the root directory /) with a tenant by having the file system entities pointed to a tenant file system entity associated with the tenant. As discussed herein, during attribute validation of any of the example file system entities 412 (My_file, Dir3, Dir2, Dir1, and the root directory /), the tenant file system entity can serve as the start of inheritance for those file system entities associated with the tenant and cause a value of a dynamically inheritable attribute of the tenant file system entity to propagate to those file system entities.

FIG. 4 illustrates how individual elements of the file My_file associated with the path name /Dir1/Dir2/Dir3/My_file are placed in five of the different segments 404. The segments 404 may be controlled or served by the servers 406 functioning as destination servers (DS). To execute an operation with respect to the file My_file, one of the computer systems 406, 406 functioning as an entry point server (ES) may request services of one or more of the servers S1, S2, and S3 functioning as destination servers (DS) that control respective segments associated with the file system entities (/, Dir1, Dir2, Dir3, My_file) in the path name /Dir1/Dir2/Dir3/My_file. As noted herein, a tenant file system entity associated with any one of the file system entities (/, Dir1, Dir2, Dir3, My_file) may be stored on any one of the segments 404.

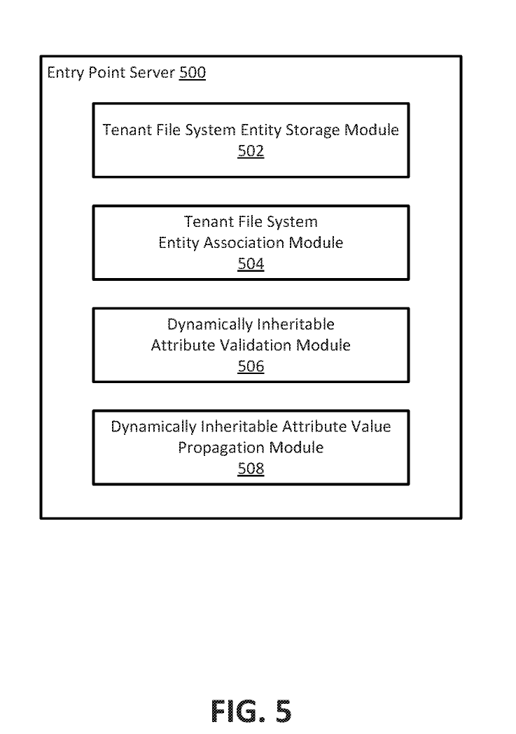

FIG. 5 is a block diagram illustrating an example entry point server 500 of an example tenant-aware distributed file system according to the present disclosure. As shown, the entry point server 500 includes a tenant file system entity storage module 502, a tenant file system entity association module 504, a dynamically inheritable attribute validation module 506, and a dynamically inheritable attribute value propagation module 508. Depending on the example, the entry point server 500 may be a computer system, such as a desktop, a server, a laptop, or a tablet. For some examples, the entry point server 500 is included in a tenant-aware distributed file system as described herein, which may be similar to the tenant-aware distributed file system 300 of FIG. 3 or the tenant-aware distributed file system 400 of FIG. 4. In various examples, the components or the arrangement of components in the entry point server 500 may differ from what is depicted in FIG. 5.

As used herein, modules and other components of various examples may comprise, in whole or in part, machine-readable instructions or electronic circuitry. For instance, a module may comprise machine-readable instructions executable by a processor to perform one or more functions in accordance with various examples described herein. Likewise, in another instance, a module may comprise electronic circuitry to perform one or more functions in accordance with various examples described herein. The elements of a module may be combined in a single package, maintained in several packages, or maintained separately.

The tenant file system entity storage module 502 may facilitate storage of a tenant file system entity on at least one segment server in a plurality of segment servers of a tenant-aware distributed file system. Depending on the example, this storage may be cause by the entry point server 500 requesting a destination server the tenant-aware distributed file system such storage.

The tenant file system entity association module 504 may facilitate association of the tenant file system entity with a set of file system entities, where the tenant file system entity includes a dynamically inheritable attribute. For some examples, a value of the dynamically inheritable attribute of the tenant file system entity is intended to be propagated to any file system entity associated with the tenant file system entity. Additionally, for some examples a value of the dynamically inheritable attribute of the tenant file system entity is not propagated to an associated file system entity until such time as the dynamically inheritable attribute of the associated file system entity is validated. As described herein, this validation may occur before the dynamically inheritable attribute is about to be used, and the validation may occur according to procedures described herein that avoid validation of all file system entity in an inheritance path.

The dynamically inheritable attribute validation module 506 may facilitate validation of the dynamically inheritable attribute of a particular file system entity in the set and to do so in response to a request to modify the particular file system entity in the set. The request to modify the particular file system entity may be received at the entry point server 500 or another entry point server in the tenant-aware distributed file system.

The dynamically inheritable attribute value propagation module 508 may facilitate propagation of a value of the dynamically inheritable attribute of the tenant file system entity to the dynamically inheritable attribute of the particular file system entity in response to validating the dynamically inheritable attribute of the particular file system entity. As described herein, during validation of the particular file system entity may involve propagation of a value of a dynamically inheritable attribute from a root of inheritance or, alternatively, from a tenant file system entity as the start of inheritance when it is determined that the particular file system entity is associated with the tenant file system entity.

For some examples, the dynamically inheritable attribute value propagation module 508 propagates the value of the dynamically inheritable attribute of the tenant file system entity to the dynamically inheritable attribute of the particular file system entity by identifying a subset of the file system entities in the set that is to receive the value of the dynamically inheritable attribute of the tenant file system entity. Additionally, in some examples, to identify the subset of the file system entities in the set, the dynamically inheritable attribute value propagation module 508 may identify the subset based on using a generation field kept at a root of the distributed file system. More particularly, the subset of file system entities identified in this manner can include those file system entities having a value of the generation field that does not match a value of the generation field at the root. As described herein, the dynamically inheritable attribute value propagation module 508 may generate a list (e.g., ordered) list of the identified file system entities, and this list may facilitate propagation of the value of the dynamically inheritable attribute of the tenant file system entity to the dynamically inheritable attribute of the particular file system entity.

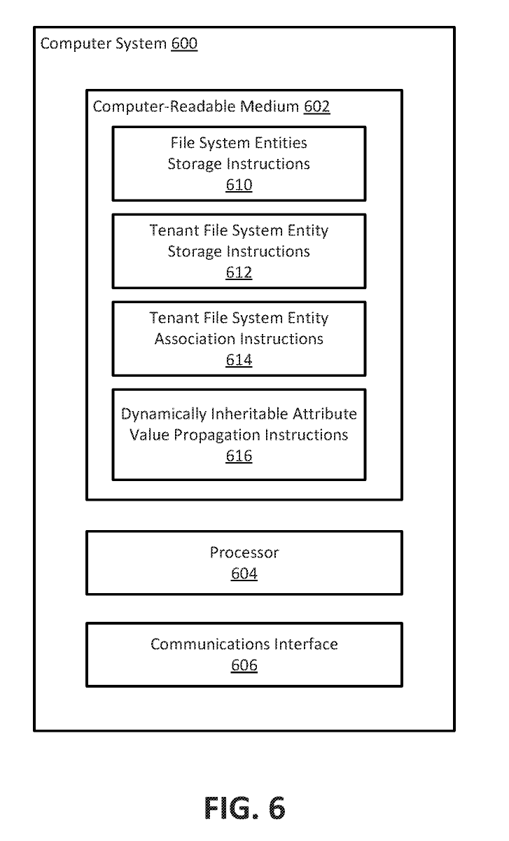

FIG. 6 is an example computer system 600 for implementing a tenant-aware file distribution file system according to the present disclosure. As shown, the computer system 600 includes a machine-readable medium 602, a processor 604, and a communications interface 606. Depending on the example, the computer system 600 may be a computer system, such as a desktop, a server, a laptop, or a tablet. Additionally, for some examples, the computer system 600 may implement an entry point server (ES), a destination server (DS), or both. In various examples, the components or the arrangement of components of the computer system 600 may differ from what is depicted in FIG. 6. For instance, the computer system 600 can include more or less components than those depicted in FIG. 6.

The machine-readable medium 602 may be any electronic, magnetic, optical, or other physical storage device that stores executable instructions. For example, the machine-readable medium 602 may be a Random Access Memory (RAM), an Electrically-Erasable Programmable Read-Only Memory (EEPROM), a storage drive, an optical disc, or the like. The machine-readable medium 602 can be encoded to store executable instructions that cause the processor 604 to perform operations in accordance with various examples described herein. In various examples, the machine-readable medium 602 is non-transitory. As shown in FIG. 6, the machine-readable medium 602 includes file system entities storage instructions 610, tenant file system entity storage instructions 612, tenant file system entity association instructions 614, and dynamically inheritable attribute value propagation instructions 616.

The processor 604 may be one or more central processing units (CPUs), microprocessors, or other hardware devices suitable for retrieval and execution of one or more instructions stored in the machine-readable medium 602. The processor 604 may fetch, decode, and execute the instructions 610, 612, 614, and 616 to enable the computer system 600 to perform operations in accordance with various examples described herein. For some examples, the processor 604 includes one or more electronic circuits comprising a number of electronic components for performing the functionality of one or more of the instructions 610, 612, 614, and 616.

The communications interface 606 may facilitate data communications between the computer system 600 and another computer system, over a communications network, to facilitate operation of a tenant-aware distributed file system as described herein. For instance, where the computer system 600 operates as an entity point server (ES) in a tenant-aware distributed file system, the computer system 600 may communicate with a destination server (DS) of the tenant-aware distributed file system to perform a file system operation. Likewise, where the computer system 600 is operating as a destination server (DS) in the tenant-aware distributed file system, the computer system 600 may communicate with a data storage device storing a segment to perform a file system operation.

The file system entities storage instructions 610 may cause the processor 604 to store, in a data storage system, a plurality of file system entities of a distributed file system that is hierarchically arranged. As described herein, a data storage system may comprise a data storage medium (e.g., hard disk drive or an array of data storage devices) capable of storing a segment described herein. In order to store the plurality of file system entities on the data storage system, a set of entry point servers (ES) of the distributed file system may request a set of destination servers (DS) of distributed file system to store the plurality of file system entities in segments they respectively manage.

The tenant file system entity storage instructions 612 may cause the processor 604 to store, in the data storage system, a tenant file system entity associated with a tenant identifier. As described herein, the tenant file system entity may include a dynamically inheritable attribute to be applied to a set of file system entities that are in the distributed file system and that are associated with the tenant file system entity. The tenant file system entity association instructions 614 may cause the processor 604 to associate a particular file system entity in the plurality with the tenant file system entity by setting a particular attribute of the particular file system entity to the tenant identifier.

The dynamically inheritable attribute value propagation instructions 616 may cause the processor 604 to propagate a value of the dynamically inheritable attribute of the tenant file system entity to the dynamically inheritable attribute of the particular file system entity, and to do so in response to validating the dynamically inheritable attribute of the particular file system entity. As described herein, validation of the dynamically inheritable attribute of the particular file system entity may occur in response to a request (e.g., by a client computer system) to an entry point server (ES) to modify the particular file system entity in the set of file system entities. Additionally, this propagation of the value of the dynamically may occur during runtime of the distribute file system.

In the foregoing description, numerous details are set forth to provide an understanding of the subject disclosed herein. However, various examples may be practiced without some or all of these details. Some examples may include modifications and variations from the details discussed above. It is intended that the appended claims cover such modifications and variations.

1. A method, comprising:
storing, in a data storage system, a plurality of file system entities of a distributed file system that is hierarchically arranged;
storing, in the data storage system, a tenant file system entity associated with a tenant identifier, the tenant file system entity including a dynamically inheritable attribute to be applied to a set of file system entities, in the distributed file system, associated with the tenant file system entity; and
associating a particular file system entity in the plurality with the tenant file system entity by setting a particular attribute of the particular file system entity to the tenant identifier.

2. The method of claim 1, wherein the particular file system entity includes the dynamically inheritable attribute, and the method comprises propagating a value of the dynamical inheritable attribute of the tenant file system entity to at least the particular file system entity.

3. The method of claim 2, comprising determining whether the dynamically inheritable attribute of the particular file system entity is to be refreshed, the propagating being in response to determining that the dynamically inheritable attribute of the particular file system entity is to be refreshed.

4. The method of claim 2, wherein propagating the value of the dynamical inheritable attribute of the tenant file system entity to at least the particular file system entity comprises:
identifying, in the plurality of file system entities, a second set of file system entities from the particular file system entity to a root of inheritance of the particular file system entity, the dynamically inheritable attribute of each file system entity in the second set having a specific value that is different from the value of the dynamic inheritable attribute of the particular file system entity; and
in response to the particular file system entity being associated with the tenant file system entity, propagating the value of the dynamically inheritable attribute of the tenant file system entity to the particular file system entity and to the second set of file system entities.

5. The method of claim 4, wherein propagating the value of the dynamical inheritable attribute of the tenant file system entity to at least the particular file system entity comprises in response to the particular file system entity not being associated with the tenant file system entity, propagating the value of the dynamically inheritable attribute of the root of inheritance to the particular file system entity and to the second set of file system entities.

6. The method of claim 1, wherein the particular attribute is another dynamically inheritable attribute.

7. The method of claim 1, wherein the tenant file system entity is hidden in namespace tree of the distributed file system.

8. The method of claim 1, wherein the dynamically inheritable attribute relates to a snapshot.

9. The method of claim 1, wherein the dynamically inheritable attribute relates to a data placement policy, track-changes information, a security policy, an audit policy, or a data replication policy.

10. The method of claim 1, wherein the distributed file system comprises a plurality of segment servers to manage respective segments of file system entities, and an entry point server to submit requests to access the distributed file system, and the method is performed by the entry point server.

11. A distributed file system, comprising:
a plurality of segment servers to manage respective segments of file system entities of a distributed file system; and
an entry point server to provide access to the distributed file system by submitting a service request to at least one segment server in the plurality, wherein the entry point server is to:
store a tenant file system entity on at least one segment server in the plurality;
associate the tenant file system entity with a set of file system entities, the tenant file system entity including a dynamically inheritable attribute;
in response to a request to modify a particular file system entity in the set of file system entities, validate the dynamically inheritable attribute of the particular file system entity; and
in response to validating the dynamically inheritable attribute of the particular file system entity, propagate a value of the dynamically inheritable attribute of the tenant file system entity to the dynamically inheritable attribute of the particular file system entity.

12. The distributed file system claim 11, wherein to propagate the value of the dynamically inheritable attribute of the tenant file system entity to the dynamically inheritable attribute of the particular file system entity, the entry point server is to identify a subset of file system entities in the set that is to receive the value of the dynamically inheritable attribute of the tenant file system entity.

13. The distributed file system claim 12, wherein the entry point server is to generate a list of the subset of file system entities, the value of the dynamically inheritable attribute of the tenant file system entity to be propagated to each file system entity in the list.

14. The distributed file system claim 12, wherein to identify the subset of file system entities in the set, the entry point server is to identify the subset of file system entities in the set based on using a generation field kept at a root of the distributed file system, each file system entity in the subset having a value of the generation field that does not match a value of the generation field at the root.

15. A non-transitory computer-readable medium having instructions stored thereon, the instructions being executable by a processor of a computer system, the instructions causing the processor to:
store, in a data storage system, a plurality of file system entities of a distributed file system that is hierarchically arranged;
store, in the data storage system, a tenant file system entity associated with a tenant identifier, the tenant file system entity including a dynamically inheritable attribute to be applied to a set of file system entities, in the distributed file system, associated with the tenant file system entity;
associate a particular file system entity in the plurality with the tenant file system entity by setting a particular attribute of the particular file system entity to the tenant identifier; and
in response to validating the dynamically inheritable attribute of the particular file system entity, propagate a value of the dynamically inheritable attribute of the tenant file system entity to the dynamically inheritable attribute of the particular file system entity.
